(19) United States
(12) Patent Application Publication
(10) Pub. No.: US 2025/0334744 A1
(43) Pub. Date: Oct. 30, 2025

(54) FUSION SPLICING SYSTEM, FUSION SPLICING METHOD, OPTICAL FIBER IDENTIFICATION SYSTEM, OPTICAL FIBER IDENTIFICATION METHOD, AND RECORDING MEDIUM

(71) Applicant: SUMITOMO ELECTRIC INDUSTRIES, LTD., Osaka (JP)

(72) Inventors: Ryosuke MEO, Raleigh, NC (US); Toshihiko HOMMA, Osaka-shi, Osaka (JP); Keitaro IWAI, Osaka-shi, Osaka (JP); Adam BROUGHTON, Raleigh, NC (US); Andrew DEGIDIO, Raleigh, NC (US); Siddharth SHETH, Alpharetta, GA (US); Viraj DAS, Alpharetta, GA (US)

(21) Appl. No.: 18/647,021

(22) Filed: Apr. 26, 2024

(51) Int. Cl. G02B 6/255

(52) U.S. Cl. CPC G02B 6/2553; G02B 6/2551; G02B 6/2555

(57) ABSTRACT

A fusion splicing system according to one embodiment includes: a process of imaging a plurality of optical fibers having colors, a process of determining whether or not an actual measurement alignment order which is an alignment order of the colors of the plurality of optical fibers in an image imaged in the process of imaging matches with a target alignment order stored in the storage unit; a process of outputting a result of the determination in the process of determining; and a process of fusion-splicing the plurality of optical fibers.

### TECHNICAL FIELD

The present disclosure relates to fusion splicing systems, fusion splicing methods, optical fiber identification systems, optical fiber identification methods, and recording media.

### BACKGROUND

Japanese Unexamined Patent Publication No. 2013-15623 describes an optical fiber fusion splicer. The optical fiber fusion splicer includes a box-shaped housing and a base for fusion provided on an upper portion of a housing. The base has a pair of optical fiber positioning units arranged to face each other. The optical fiber positioning unit positions a bare fiber which is a portion from which coating of a distal end portion of an optical fiber has been removed. A plurality of V-shaped cross-sectional fiber grooves positioning the bare fibers are formed on an upper surface of each of the optical fiber positioning units. A plurality of the optical fibers are positioned in a fiber positioning unit by positioning each of the plurality of bare fibers in each fiber groove.

### SUMMARY

A fusion splicing system according to the present disclosure includes an imaging unit imaging a plurality of optical fibers having colors, a storage unit storing a target alignment order which is an alignment order of target colors of the plurality of optical fibers, a determination unit determining whether or not an actual measurement alignment order which is an alignment order of the colors of the plurality of optical fibers in an image imaged by the imaging unit matches with the target alignment order stored in the storage unit, an output unit outputting a result of the determination by the determination unit, and a fusion splicing unit fusion-splicing the plurality of optical fibers.

### BRIEF DESCRIPTION OF THE DRAWINGS

FIG. 1 is a perspective view illustrating an exemplary fusion splicer;

FIG. 2 is a perspective view illustrating an internal structure of the fusion splicer of FIG. 1;

FIG. 3 is a diagram schematically illustrating a hardware configuration of the fusion splicer of FIG. 1;

FIG. 4 is a plan view illustrating a plurality of optical fibers;

FIG. 5 is a diagram illustrating an example of configurations of a fusion splicing system and an optical fiber identification system;

FIG. 6 is a schematic diagram illustrating a hardware configuration of a mobile terminal;

FIG. 7 is a diagram illustrating an example of a terminal mounting portion mounted on the mobile terminal;

FIG. 8 is a perspective view illustrating a holder mounting portion of a light shielding member mounted on the mobile terminal through a terminal mounting portion of FIG. 7;

FIG. 9 is a diagram illustrating an example of a screen for storing a target alignment order in a storage unit of the fusion splicing system of FIG. 5;

FIG. 10 is a diagram illustrating an example of the screen for storing the target alignment order in the storage unit of the fusion splicing system of FIG. 5;

FIG. 11 is a diagram illustrating an example of an output of a result of the determination by a determination unit of the fusion splicing system of FIG. 5;

FIG. 12 is a diagram illustrating another example of the output of a result of the determination by the determination unit of the fusion splicing system of FIG. 5;

FIG. 13 is a flowchart illustrating exemplary processes of a fusion splicing method;

FIG. 14 is a diagram illustrating a configuration of a fusion splicing system according to Modified Example;

FIG. 15 is a diagram illustrating an example of a screen imaged by an imaging unit of the fusion splicing system of FIG. 14;

FIG. 16 is a flowchart illustrating processes of a fusion splicing method according to Modified Example;

FIG. 17 is a diagram illustrating configurations of a fusion splicing system and an optical fiber identification system according to Modified Example;

FIG. 18 is a diagram illustrating configurations of the fusion splicing system and the optical fiber identification system according to Modified Example; and

FIG. 19 is a diagram schematically illustrating hardware configurations of servers of FIGS. 17 and 18.

### DETAILED DESCRIPTION

For example, when fusion-splicing a plurality of optical fibers, a plurality of optical fibers need to be aligned so that an alignment order of the plurality of optical fibers is appropriate. However, a present situation is that a work of aligning the plurality of optical fibers is performed visually. In some cases, visual alignment of the plurality of optical fibers is difficult. When the plurality of optical fibers are visually aligned, an error may occur in the alignment order of the plurality of optical fibers. Therefore, easily and accurately aligning of the plurality of optical fibers is required.

An object of the present disclosure is to provide a fusion splicing system, a fusion splicing method, an optical fiber identification system, an optical fiber identification method, and an optical fiber identification program capable of easily and accurately aligning a plurality of optical fibers.

(1) A fusion splicing system according to an embodiment includes an imaging unit imaging a plurality of optical fibers having colors, a storage unit storing a target alignment order which is an alignment order of target colors of the plurality of optical fibers, a determination unit determining whether or not an actual measurement alignment order which is an alignment order of the colors of the plurality of optical fibers in an image imaged by the imaging unit matches with the target alignment order stored in the storage unit, an output unit outputting a result of the determination by the determination unit, and a fusion splicing unit fusion-splicing the plurality of optical fibers.

The fusion splicing system has the storage unit. The storage unit stores the target alignment order which is an alignment order of target colors of the plurality of optical fibers having the colors. The plurality of optical fibers are imaged by the imaging unit. The determination unit determines whether or not the actual measurement alignment order which is an alignment order of the colors of the plurality of optical fibers in an image imaged by the imaging unit matches with the target alignment order. The result of the determination by the determination unit is output by the output unit. An operator performing a work of aligning the plurality of optical fibers can grasp whether or not the actual measurement alignment order of the plurality of optical fibers in the imaged image matches with the target alignment order stored in the storage unit. Therefore, the operator can easily and accurately align the plurality of optical fibers.

(2) In the above-described (1), the imaging unit may be an imaging unit of a mobile terminal. At least a portion of the determination unit may be at least a portion of a determination unit of the mobile terminal, and the determination unit may be implemented by an application installed in the mobile terminal. In this case, it is determined whether or not the actual measurement alignment order of the plurality of optical fibers imaged by the imaging unit of the mobile terminal matches with the target alignment order, and the result of the determination is output to the mobile terminal. The operator can grasp the result of the determination by imaging the plurality of optical fibers with the imaging unit of the mobile terminal and manipulating the mobile terminal. Therefore, the operator can more easily align the plurality of optical fibers.

(3) In the above-described (2), the fusion splicing system may include a light shielding member having a holder mounting portion on which an optical fiber holder holding the plurality of the optical fibers is mounted and a terminal mounting portion on which the mobile terminal is mounted. In the light shielding member, a lens of a camera of the mobile terminal mounted on the terminal mounting portion may face the plurality of optical fibers held by the optical fiber holder mounted on the holder mounting portion, and a light to the lens may be shielded. In this case, the camera of the mobile terminal mounted on the terminal mounting portion is shielded from the light and faces the plurality of optical fibers held by the optical fiber holder. Accordingly, the light entering the camera of the mobile terminal can be suppressed, and the camera can be allowed to face the plurality of optical fibers, so that a clearer image of the optical fibers can be acquired. Therefore, the accuracy of the determination of the plurality of optical fibers can be further improved.

(4) In the above-described (3), the holder mounting portion may include an attachment portion detachably mounted on the terminal mounting portion and an arrangement portion in which the optical fiber holder holding the plurality of optical fibers is arranged.

(5) In the above-described (4), the terminal mounting portion may have a lens facing portion facing the lens of the camera of the mobile terminal, and the attachment portion may have a hole into which the lens facing portion is fitted.

(6) In any one of the above-described (1) to (5), the output unit may display whether or not the actual measurement alignment order matches with the target alignment order, on the display of the mobile terminal.

(7) In any one of the above-described (1) to (6), the output unit may display whether or not the actual measurement alignment order matches with the target alignment order for each optical fiber on the display.

(8) In the above-described (6), the output unit may display an image illustrating the actual measurement alignment order and an image illustrating the target alignment order on the display. In this case, since the actual measurement alignment order together with the target alignment order is displayed on the display, the suitability of the alignment order of the optical fibers can be visually displayed in an easy-to-understand manner.

(9) In the above-described (1), the imaging unit may be an imaging unit of a fusion splicer. At least a portion of the determination unit may be at least a portion of a determination unit of the fusion splicer, and the determination unit may be implemented by software installed in the fusion splicer. In this case, it is determined whether or not the actual measurement alignment order which is an alignment order of the colors of the plurality of optical fibers imaged by the imaging unit of the fusion splicer matches with the target alignment order, and a result of the determination is output to the fusion splicer. The operator can grasp the result of the determination by imaging the plurality of optical fibers with the imaging unit of the fusion splicer and manipulating the fusion splicer. Therefore, the operator can easily and accurately align the plurality of optical fibers in the fusion splicer.

(10) In the above-described (9), the fusion splicer may include a housing, a cover covering the housing, and a camera mounted on the inside of the cover, and the imaging unit may image the plurality of optical fibers with the camera.

(11) A fusion splicing method according to the present disclosure includes imaging a plurality of optical fibers having colors, determining whether or not an actual measurement alignment order which is an alignment order of the colors of the plurality of optical fibers in an image imaged in the imaging matches with a target alignment order stored in a storage unit, outputting a result of the determination in the determining, and fusion-splicing the plurality of optical fibers.

(12) An optical fiber identification system according to the present disclosure includes an imaging unit imaging a plurality of optical fibers having colors, a storage unit storing a target alignment order which is an alignment order of target colors of the plurality of optical fibers, a determination unit determining whether or not an actual measurement alignment order which is an alignment order of the colors of the plurality of optical fibers in an image imaged by the imaging unit matches with the target alignment order stored in the storage unit, and an output unit outputting a result of the determination by the determination unit.

(13) An optical fiber identification method according to the present disclosure includes imaging a plurality of optical fibers having colors, determining whether or not an actual measurement alignment order which is an alignment order of the colors of the plurality of optical fibers in an image imaged in the imaging matches with a target alignment order stored in the storage unit, and outputting a result of the determination in the determining.

In the fusion splicing method of (11), the optical fiber identification system of (12), and the optical fiber identification method of (13), the target alignment order which is an alignment order of target colors of the plurality of optical fibers is stored in advance in the storage unit. The plurality of optical fibers are imaged by the imaging unit, and the actual measurement alignment order in the imaged image is determined. In the determining, it is determined whether or not the actual measurement alignment order in the imaged image matches with the target alignment order stored in the storage unit. An operator performing a work of aligning the plurality of optical fibers can grasp whether or not the actual measurement alignment order in the imaged image matches with the target alignment order stored in the storage unit. Therefore, the operator can easily and accurately align the plurality of optical fibers.

(14) In the above-described (13), the optical fiber identification method may include storing the target alignment order in the storage unit. In this case, the target alignment order to be stored in advance in the storage unit can be arbitrarily set.

(15) A recording medium according to the present disclosure is a computer-readable recording medium recording an optical fiber identification program to execute imaging a plurality of optical fibers having colors, determining whether or not an actual measurement alignment order which is an alignment order of the colors of the plurality of optical fibers in an image imaged in the imaging matches with a target alignment order stored in the storage unit, and outputting a result of the determination in the determining.

In the optical fiber identification program recorded on this recording medium, the plurality of optical fibers are imaged by the imaging unit, and the actual measurement alignment order of the plurality of optical fibers in the imaged image is determined. In the determining, it is determined whether or not the actual measurement alignment order of the plurality of optical fibers in the imaged image matches with the target alignment order stored in the storage unit. An operator performing a work of aligning the plurality of optical fibers can grasp whether or not the actual measurement alignment order in the imaged image matches with the target alignment order stored in the storage unit. Therefore, the same effect as the above-described optical fiber identification method can be obtained from this optical fiber identification program.

(16) In the above-described (15), in the recording medium, the optical fiber identification program including storing the target alignment order in the storage unit by manipulating a mobile terminal may be recorded.

Each process (each function) of the embodiments of the present disclosure is implemented by a processing circuit (Circuitry) including one or more processors. The processing circuit may be configured by an integrated circuit or the like in which one or a plurality of memories, various analog circuits, and various digital circuits are combined in addition to one or a plurality of processors. The one or plurality of memories store programs (commands) causing the one or plurality of processors to execute the processes. The one or plurality of processors may execute each of the processes according to the program read from the one or plurality of memories or may execute each of the processes according to a logic circuit designed in advance to execute each of the processes. The processor may be a CPU (central processing unit), a GPU (graphics processing unit), a DSP (digital signal processor), an FPGA (field programmable gate array), an ASIC (application specific integrated circuit), or various other processors suitable for control of a computer. It is noted that the plurality of processors physically separated may cooperate with each other to execute the above-described processes. For example, the processors mounted on the plurality of respective computers physically separated cooperate with each other via a network such as a LAN (local area network), a WAN (wide area network), or the Internet to execute the above-described processes. The program may be installed in a memory from an external server device or the like via the network or may be distributed in a state of being stored in a recording medium such as a CD-ROM (compact disc read only memory), a DVD-ROM (digital versatile disk read only memory), a semiconductor memory, or the like and installed in the memory from the recording medium.

The present invention can be implemented as a fusion splicing system or an optical fiber identification system having an imaging unit, a storage unit, a determination unit, and an output unit, can be implemented as a fusion splicing method or an optical fiber identification method having corresponding processes as steps, can be implemented as an optical fiber identification program for causing a computer to execute corresponding steps. In addition, the fusion splicing system may be a system including the entire fusion splicer or may be a system including a portion of the fusion splicer.

Hereinafter, specific examples of the fusion splicing system, the fusion splicing method, the optical fiber identification system, the optical fiber identification method, and the optical fiber identification program according to the embodiments will be described. It is noted that the fusion splicing system, the fusion splicing method, the optical fiber identification system, the optical fiber identification method, and the optical fiber identification program according to the present disclosure may be configured by arbitrarily combining at least a portion of the forms described below. In the description of the drawings, the same or corresponding elements are denoted by the same reference numerals, and redundant descriptions are omitted as appropriate. In some cases, the drawings may be partially simplified or exaggerated for easier understanding, and dimensional ratios and the like are not limited to those described in the drawings.

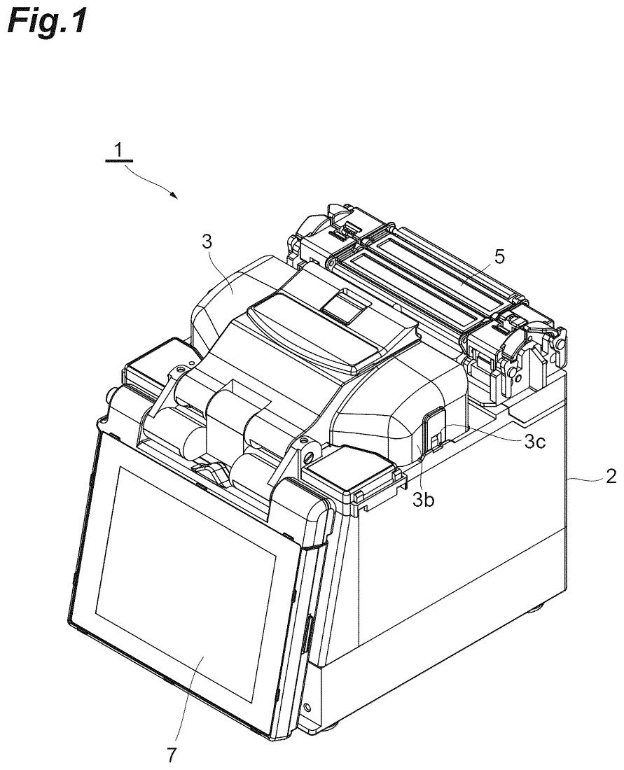

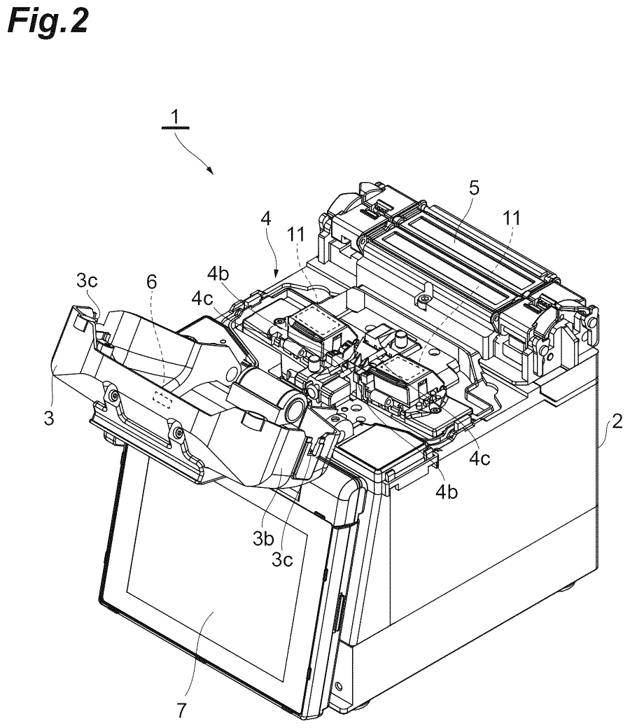

FIG. 1 is a perspective view illustrating a fusion splicer 1 as an example. The fusion splicer 1 includes a box-shaped housing 2 and a cover 3 covering the housing 2. FIG. 2 is a perspective view illustrating a state where the cover 3 of the fusion splicer 1 is opened. The fusion splicer 1 fusion-splices a plurality of optical fibers to a plurality of other optical fibers. The fusion splicer 1 has a fusion splicing unit 4 fusing the plurality of optical fibers together and a heater 5 heating and shrinking a sleeve for reinforcement, covering the fusion splicing unit of the optical fibers fused in the fusion splicing unit 4, on the upper portion of the housing 2. Furthermore, the fusion splicer 1 has a camera 6 imaging the plurality of optical fibers and a monitor 7 displaying the state of fusion splicing of the optical fibers imaged by the camera 6. The camera 6 is mounted, for example, inside the cover 3.

The cover 3 is a windshield cover preventing wind from entering the fusion splicing unit 4. The cover 3 is connected to the housing 2 so as to openably and closably cover the fusion splicing unit 4. The cover 3 has a pair of side faces 3b. An inlet 3c introducing the optical fiber into the fusion splicing unit 4 is formed on each side face 3b of the cover 3. The fusion splicing unit 4 includes a holder mounting portion on which a pair of optical fiber holders 11 holding the plurality of optical fibers can be mounted, a pair of fiber positioning units 4b defining positions of the plurality of optical fibers, and a pair of electrodes 4c performing discharge. The optical fiber introduced from the inlet 3c of the cover 3 reaches the optical fiber holder 11 located inside the fusion splicing unit 4.

The electrode 4c is also referred to as an electrode rod. The electrode 4c fuses distal ends of the optical fibers by arc discharge. Each optical fiber that is a fusing target is held by the optical fiber holder 11, and each optical fiber holder 11 is mounted and fixed on the holder mounting portion. The fiber positioning unit 4b is arranged between the pair of optical fiber holders 11. The fiber positioning unit 4b positions the distal end portion of the optical fiber fixed to each optical fiber holder 11. The pair of electrodes 4c are arranged between the pair of fiber positioning units 4b.

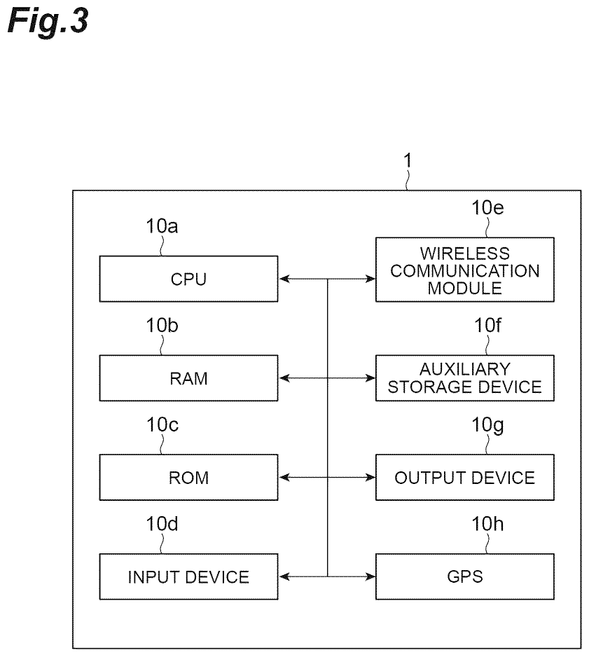

FIG. 3 is a diagram schematically illustrating an example of a hardware configuration of the fusion splicer 1. As illustrated in FIG. 3, the fusion splicer 1 has a configuration of including a computer including hardware such as a CPU 10a, a RAM 10b, a ROM 10c, an input device 10d such as a touch panel (monitor 7) for accepting an input of user manipulation, a wireless communication module 10e wirelessly transmitting and receiving data, an auxiliary storage device 10f such as a semiconductor memory or a hard disk, and an output device 10g such as the display (monitor 7). The fusion splicer 1 operates the hardware according to programs loaded into the hardware of the RAM 10b and the like under the control of the CPU 10a and reads and writes data in the RAM 10b, the auxiliary storage device 10f, and the like to implement each function of the fusion splicer 1. The fusion splicer 1 may include a device acquiring position information such as a GPS 10h and may be configured to acquire the position information of the fusion splicer 1 such as longitude or latitude from the GPS 10h. Various operations of the fusion splicer 1 are controlled by predetermined software stored in the auxiliary storage device 10f.

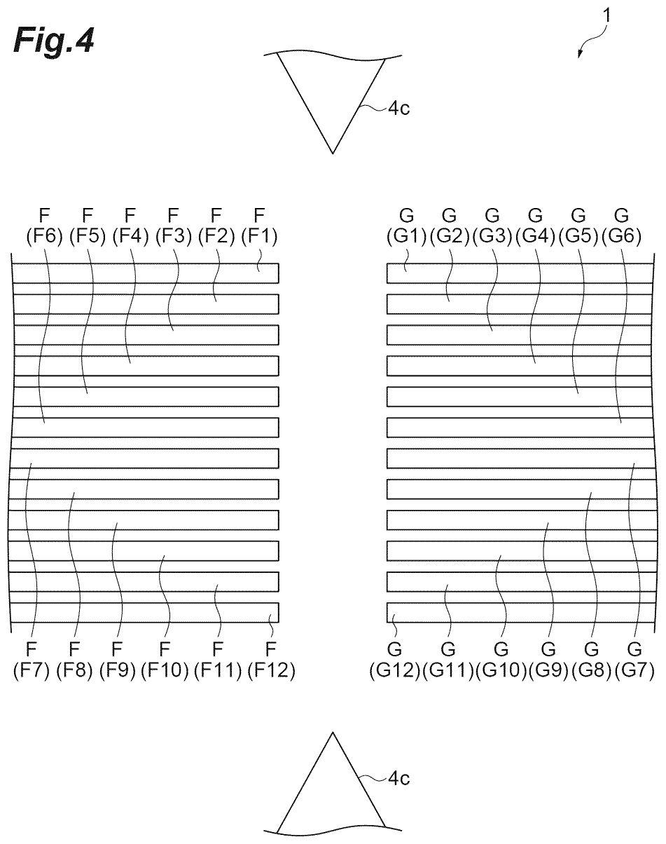

FIG. 4 is a diagram schematically illustrating the plurality of optical fibers aligned in the fusion splicer 1 and fusion-spliced in the fusion splicer 1. As illustrated in FIG. 4, for example, optical fibers F1, F2, F3, F4, F5, F6, F7, F8, F9, F10, F11, and F12 that are the plurality of optical fibers having different colors are aligned in the fusion splicer 1. Further, optical fibers G1, G2, G3, G4, G5, G6, G7, G8, G9, G10, G11, and G12 fusion-spliced with each of the optical fibers F1, F2, F3, F4, F5, F6, F7, F8, F9, F10, F11, and F12 are aligned in the fusion splicer 1.

The optical fibers F1, F2, F3, F4, F5, F6, F7, F8, F9, F10, F11, and F12 are aligned in this order. The optical fibers G1, G2, G3, G4, G5, G6, G7, G8, G9, G10, G11, and G12 are aligned in this order. For example, the colors of the plurality of optical fibers G are different from each other. In the following description, the optical fibers F1, F2, F3, F4, F5, F6, F7, F8, F9, F10, F11, and F12 are collectively referred to as optical fibers F when there is no need to distinguish the optical fibers. The optical fibers G1, G2, G3, G4, G5, G6, G7, G8, G9, G10, G11, and G12 are also collectively referred to as optical fibers G when there is no need to distinguish the optical fibers.

The color of the optical fiber F1 is the same as the color of the optical fiber G1, and the color of the optical fiber F2 is the same as the color of the optical fiber G2. Similarly, the colors of each of the optical fibers F3, F4, F5, F6, F7, F8, F9, F10, F11, and F12 are the same as the colors of the optical fibers G3, G4, G5, G6, G7, G8, G9, G10, G11, and G12.

For example, the colors of the optical fibers F1, F2, F3, F4, F5, F6, F7, F8, F9, F10, F11, and F12 (optical fibers G1, G2, G3, G4, G5, G6, G7, G8, G9, G10, G11, and G12) are blue, orange, green, brown, gray, white, red, black, yellow, purple, pink, and light blue, respectively. As an example, the fusion splicing is performed with the optical fibers F1, F2, F3, F4, F5, F6, F7, F8, F9, F10, F11, and F12 aligned in this color order. However, the order of the colors is not limited to the above-described example and can be changed as appropriate.

The optical fiber F1 is fusion-spliced to the optical fiber G1, and the optical fiber F2 is fusion-spliced to the optical fiber G2. Similarly, the optical fibers G3, G4, G5, G6, G7, G8, G9, G10, G11, and G12 are fusion-spliced to the optical fibers F3, F4, F5, F6, F7, F8, F9, F10, F11, and F12, respectively. In the case of being aligned as described above, the optical fibers F1, F2, F3, F4, F5, F6, F7, F8, F9, F10, F11, and F12 are fusion-spliced to the optical fibers G1, G2, G3, G4, G5, G6, G7, G8, G9, G10, G11, and G12.

For example, the plurality of optical fibers F (plurality of optical fibers G) are aligned at regular intervals. The pitch of the optical fibers F (optical fibers G) is, for example, 200 μm or more and 250 μm or less. The fusion splicer 1 collectively fuses the plurality of optical fibers F to the plurality of optical fibers G. Before this fusion splicing, as described above, the plurality of optical fibers F and the plurality of optical fibers G need to be aligned in an appropriate order. In the above-described example, the optical fibers F1, F2, F3, F4, F5, F6, F7, F8, F9, F10, F11, and F12 need to be aligned in this order, and the optical fibers G1, G2, G3, G4, G5, G6, G7, G8, G9, G10, G11, and G12 need to be aligned in this order. However, the present situation is that a work of aligning the plurality of optical fibers F and the plurality of optical fibers G in an appropriate order and visually confirming that the order is appropriate is difficult. Furthermore, in the work of visually aligning the plurality of optical fibers F and the plurality of optical fibers G, there is a possibility that the order of the optical fibers may be changed due to human error, resulting in the inappropriate order.

In the fusion splicing system, the fusion splicing method, the optical fiber identification system, the optical fiber identification method, and the optical fiber identification program according to the embodiments, the operator aligning the optical fibers is enabled to grasp whether or not the alignment order of the optical fibers is appropriate. Therefore, the possibility of easily performing the work of confirming the order of the plurality of optical fibers F and the order of the plurality of optical fibers G and changing the order of the optical fibers F and the optical fibers G can be reduced. Hereinafter, examples of the fusion splicing system, the fusion splicing method, the optical fiber identification system, the optical fiber identification method, and the optical fiber identification program according to the embodiments will be described.

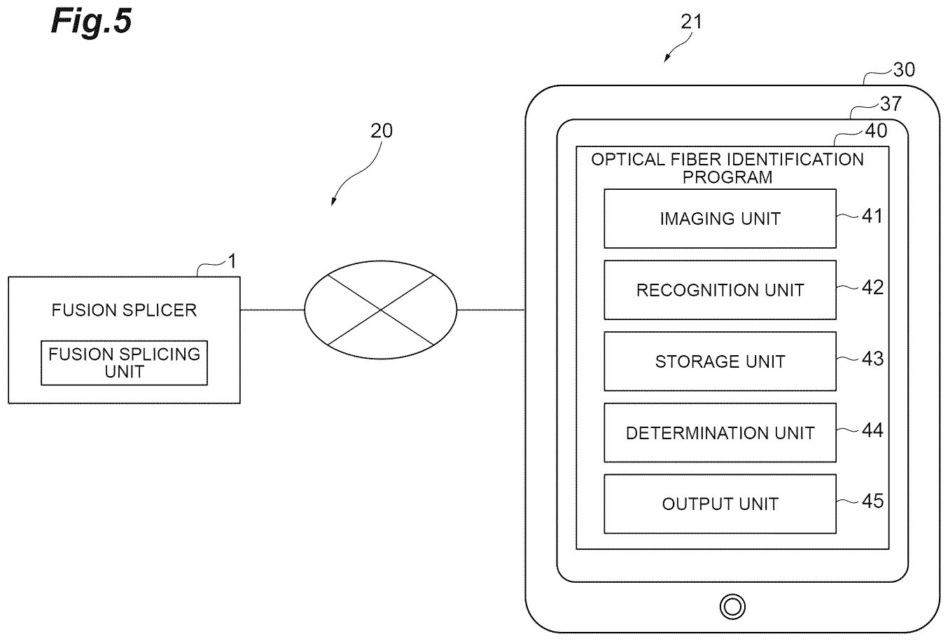

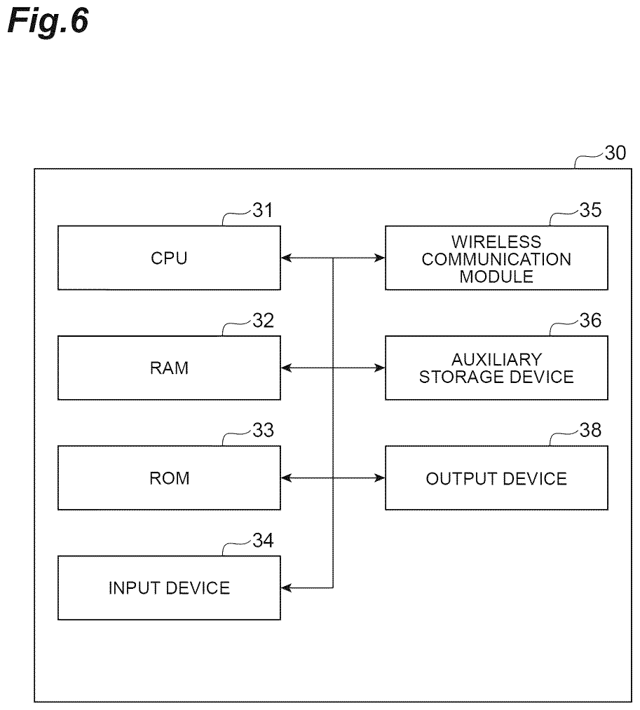

FIG. 5 is a diagram illustrating configurations of a fusion splicing system 20 and an optical fiber identification system 21 as an example. The fusion splicing system 20 has a fusion splicer 1 and a mobile terminal 30. The mobile terminal 30 is, for example, a mobile wireless communication terminal such as a smart phone or a tablet. The mobile terminal 30 is configured to be able to communicate with, for example, the fusion splicer 1. However, the mobile terminal 30 may not be able to communicate with the fusion splicer 1. FIG. 6 is a diagram illustrating a hardware configuration of the mobile terminal 30. As illustrated in FIGS. 5 and 6, the mobile terminal 30 has a CPU 31, a RAM 32, a ROM 33, an input device 34, a wireless communication module 35, an auxiliary storage device 36, and an output device 38. Hereinafter, the RAM 32 and the ROM 33 may be collectively referred to as a memory. Each function of an optical fiber identification program 40 described later is implemented by operations of these components by a program.

In this embodiment, the optical fiber identification system 21 has the mobile terminal 30. For example, the optical fiber identification program 40 is installed in the mobile terminal 30. The mobile terminal 30 has a display 37 displaying the functions of the optical fiber identification program 40. The optical fiber identification program 40 is, for example, a program recognizing the colors of the plurality of optical fibers F aligned and determining whether or not the alignment order of the plurality of optical fibers F is appropriate according to the recognized colors. The optical fiber identification program 40 includes, for example, an imaging unit 41 imaging the plurality of optical fibers F, a recognition unit 42 recognizing the colors of the optical fibers F in the imaged image, a storage unit 43 storing the target alignment order of the plurality of optical fibers F, a determination unit 44 determining whether or not the alignment order of the imaged plurality of optical fibers F is appropriate, and an output unit 45 outputting a result of the determination by the determination unit 44. The target alignment order is an alignment order of target colors of the plurality of optical fibers F. The actual measurement alignment order is the alignment order of the colors of the plurality of optical fibers F in the image imaged by the imaging unit 41.

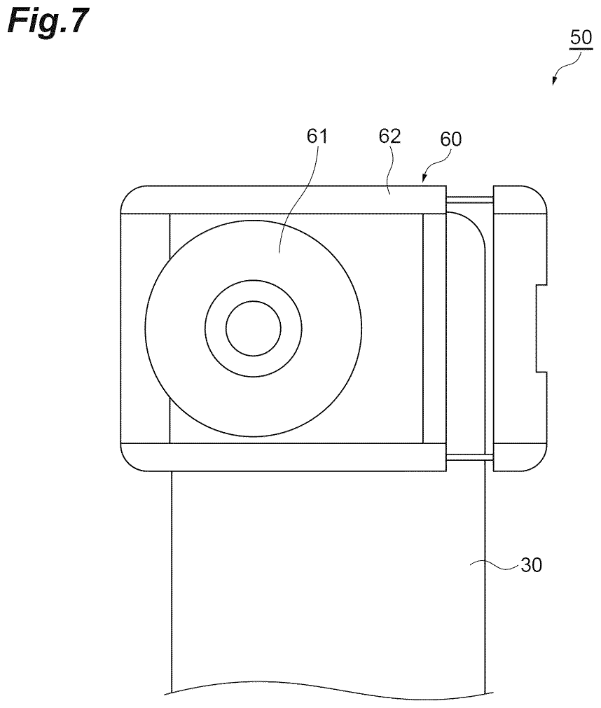

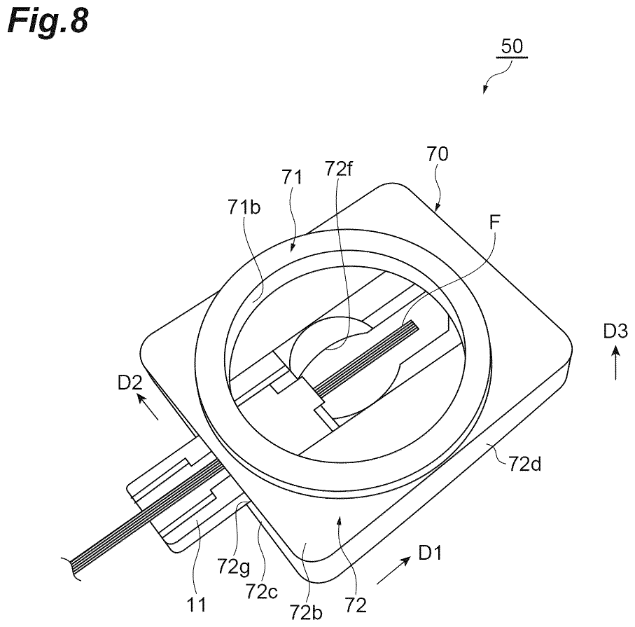

For example, the imaging unit 41 images the plurality of optical fibers F with the camera of the mobile terminal 30. The imaging of the optical fiber F by the imaging unit 41 is implemented by the CPU 31 of the mobile terminal 30 and the camera of the mobile terminal 30. For example, the fusion splicing system 20 and the optical fiber identification system 21 include a light shielding member shielding a lens of the camera of the mobile terminal 30 from the light. FIGS. 7 and 8 are diagrams illustrating a light shielding member 50 as an example. As illustrated in FIGS. 7 and 8, the light shielding member 50 includes a terminal mounting portion 60 on which the mobile terminal 30 is mounted and a holder mounting portion 70 on which the optical fiber holder 11 holding the plurality of optical fibers F is mounted.

The terminal mounting portion 60 includes, for example, a lens facing portion 61 facing the lens of the camera of the mobile terminal 30 and a holding mechanism 62 movably holding the lens facing portion 61 in both the width direction (horizontal direction in FIG. 7) of the mobile terminal 30 and the longitudinal direction (vertical direction in FIG. 7) of the mobile terminal 30. The lens facing portion 61 incorporates the lens magnifying the images of the plurality of optical fibers F. By facing the lens facing portion 61 to the lens of the camera of the mobile terminal 30, the magnification of the images of the plurality of optical fibers F without degrading the image quality can be increased.

The holding mechanism 62 is mounted on the mobile terminal 30. The holding mechanism 62 is slidable along the longitudinal direction (vertical direction in FIG. 7) of the mobile terminal 30 in a state of being mounted on the mobile terminal 30. The lens facing portion 61 is slidable relative to the holding mechanism 62 in the width direction (horizontal direction in FIG. 7) of the mobile terminal 30. In the terminal mounting portion 60, the position of the holding mechanism 62 in the longitudinal direction of the mobile terminal 30 can be adjusted, and the position of the lens facing portion 61 in the width direction of the mobile terminal 30 can be adjusted. Therefore, in the terminal mounting portion 60, the lens facing portion 61 can be easily aligned with the lenses of various mobile terminals 30. Heretofore, the example of the configuration of the terminal mounting portion 60 has been described. However, the configuration of the terminal mounting portion 60 is not limited to the example described above and can be changed as appropriate.

The holder mounting portion 70 has an attachment portion 71 detachably mounted on the terminal mounting portion 60 and an arrangement portion 72 in which the optical fiber holder 11 holding the plurality of optical fibers F is arranged. The holder mounting portion 70 has, for example, a plate-like shape. The attachment portion 71 and the arrangement portion 72 are aligned along a plate thickness direction (vertical direction in FIG. 8) of the holder mounting portion 70. For example, the attachment portion 71 has a hole 71b into which the lens facing portion 61 of the terminal mounting portion 60 is fitted. The hole 71b penetrates the attachment portion 71 in the plate thickness direction of the holder mounting portion 70. For example, the shape of the attachment portion 71 when viewed along the plate thickness direction of the holder mounting portion 70 is annular.

The arrangement portion 72 extends in a first direction D1 and a second direction D2 intersecting the first direction D1 and has a plate-like shape having a thickness in a third direction D3 intersecting both the first direction D1 and the second direction D2. The third direction D3 is a plate thickness direction of the holder mounting portion 70. The arrangement portion 72 has a main face 72b extending in the first direction D1 and the second direction D2, a first end face 72c extending in the second direction D2 and the third direction D3, and a second end face 72d extending in the first direction D1 and the third direction D3.

The attachment portion 71 protrudes from the main face 72b in the third direction D3. The arrangement portion 72 has a hole 72f communicating with the hole 71b of the attachment portion 71. The hole 72f is recessed from the main face 72b. The hole 72f penetrates, for example, the arrangement portion 72 in the third direction D3. The arrangement portion 72 has an insertion portion 72g into which the optical fiber holder 11 is inserted. The insertion portion 72g extends from the first end face 72c in the first direction D1 and extends to the hole 72f.

The optical fiber holder 11 holding the plurality of optical fibers F is inserted into the insertion portion 72g to enter the hole 72f and is exposed in the hole 72f in the third direction D3. In this state, the lens facing portion 61 of the terminal mounting portion 60 mounted on the mobile terminal 30 is fitted into the hole 71b of the attachment portion 71. Accordingly, in the light shielding member 50, the lenses of the camera of the mobile terminal 30 face the plurality of optical fibers F in the holes 71b and 72f, and the light from the outside world is shielded, so that excess light entering the lens can be reduced. Accordingly, the images of the plurality of optical fibers F can be acquired more accurately, and the colors of the plurality of optical fibers F can be recognized more accurately.

The recognition unit 42 illustrated in FIG. 5 recognizes the colors of the plurality of optical fibers F from the images of the plurality of optical fibers F imaged. The recognition of the color of the optical fiber F by the recognition unit 42 is implemented, for example, by the CPU 31 of the mobile terminal 30 and the memory of the mobile terminal 30. For example, the recognition unit 42 acquires color parameters of the images of the plurality of optical fibers F imaged by the imaging unit 41 and acquires the colors of the optical fibers F as the color parameters. The color parameter indicates a parameter obtained by quantifying the color of the image.

For example, the recognition unit 42 acquires respective color parameters of the plurality of optical fibers F in the image imaged by the imaging unit 41. As a specific example, the recognition unit 42 acquires the color parameters of the optical fibers F1, F2, F3, F4, F5, F6, F7, F8, F9, F10, F11, and F12 in the image.

The recognition unit 42 acquires, for example, RGB values from the respective optical fibers F of the image. In this case, the color parameters of the image acquired by the recognition unit 42 are color parameters of an RGB color system. However, the color parameters of the image acquired by the recognition unit 42 may be color parameters of an L*a*b* color system including an L* value, an a* value, and a b* value, color parameters of an XYZ color system, color parameters of a CIE 1931 color space, color parameters of an L*C*h* color space, or color parameters of a Hunter Lab color space and can be changed as appropriate.

The storage unit 43 stores the target alignment order which is, for example, an appropriate alignment order of the colors of the optical fibers F in advance. The function of the storage unit 43 is implemented by the memory of, for example, the mobile terminal 30. For example, the optical fiber identification program 40 has a process of storing the target alignment order in the storage unit 43 by manipulating the mobile terminal 30. In this case, by manipulating the mobile terminal 30, the target alignment order of the optical fibers F can be stored in the storage unit 43.

Regarding each of the colors in the target aligning order to be stored in advance, parameters directly comparable with the color information to be extracted at the recognition unit 42 are set and stored. If the parameters are set by color parameters, the color parameters of the RGB color system, the color parameters of an L*a*b* color system including an L* value, an a* value, and a b* value, color parameters of an XYZ color system, color parameters of a CIE 1931 color space, color parameters of an L*C*h* color space, or color parameters of a Hunter Lab color space may be used. Alternatively, the color information to be the criteria may be determined by machine learning based on the plurality of images of the optical fibers with the color name already identified.

For example, the color parameters corresponding to each of the plurality of images of the optical fibers and the range of color parameter variation and the like may be obtained, then the range of the color parameters corresponding to the specific color name may be automatically determined based on, for example, the median value, the mean value, the standard deviation, the maximum value, and the minimum value of the color parameters, and the determined range of the color parameters may be stored. The range determined as such may be set as the color criteria. Alternatively, the color parameter information corresponding to the specific color name may be stored as a data table.

Alternatively, the image information of the optical fibers per se corresponding to the specific color name may be associated so as to be the color criteria, and the color information may be identified based on the level of correlation between the image of the optical fiber F acquired by the recognition unit 42 and the group of images that is the color criteria.

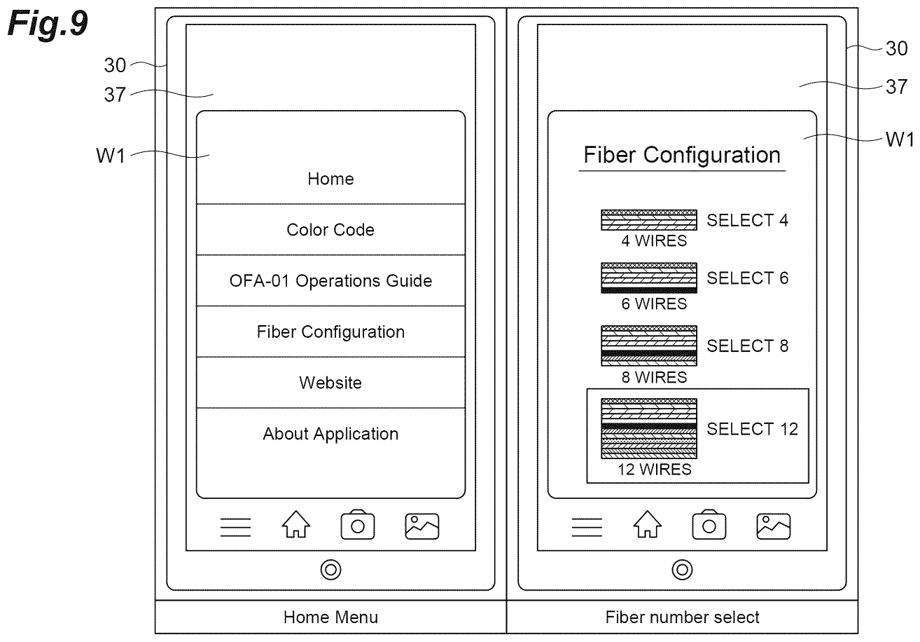

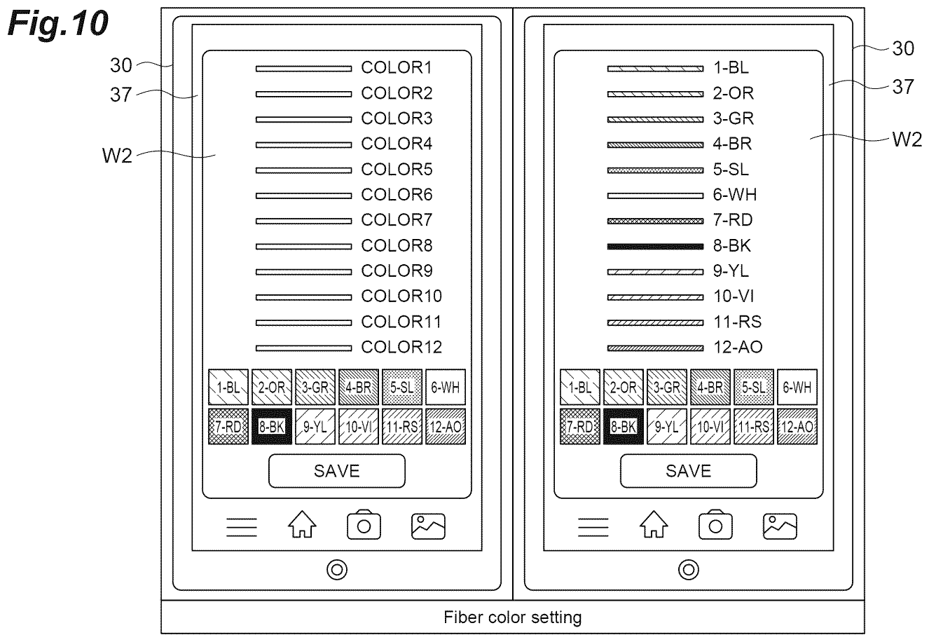

FIGS. 9 and 10 illustrate examples of screens for storing the target alignment order in the storage unit 43. Hereinafter, a specific example of a method for storing the target alignment order in the storage unit 43 will be described. First, a setting screen W1 displayed on the display 37 of the mobile terminal 30 is manipulated to select the same number of optical fibers as the number of the optical fibers F. FIG. 9 illustrates the example where a “Fiber Configuration” button displayed on the display 37 is pressed and 12 is selected as the number of optical fibers F on the setting screen W1.

After the number of optical fibers F is selected, a screen W2 for setting the target alignment order of the optical fibers F is displayed on the display 37. For example, the target alignment order of the optical fibers F1, F2, F3, F4, F5, F6, F7, F8, F9, F10, F11, and F12 is set on the screen W2. An example where the target alignment order of the colors of the optical fibers F1, F2, F3, F4, F5, F6, F7, F8, F9, F10, F11, and F12 is set as blue, orange, green, brown, gray, white, red, black, yellow, purple, pink, and light blue is illustrated in FIG. 10. After the target alignment order of the optical fibers F is set, the target alignment order of the optical fibers F is stored in the storage unit 43 by pressing a “Save” button on the screen W2.

The determination unit 44 determines whether or not the actual measurement alignment order which is an alignment order of the plurality of optical fibers F in the image imaged by the imaging unit 41 matches with the target alignment order stored in the storage unit 43. The determination unit 44 is implemented by the CPU 31 of mobile terminal 30 operating according to commands of an application installed in the mobile terminal 30. For example, the determination unit 44 determines whether or not the color parameters of the image acquired by the recognition unit 42 match with the color parameters of the target alignment order stored in the storage unit 43. The determination unit 44 performs the determination by comparing the target alignment order and the actual measurement alignment order of the plurality of optical fibers F acquired by the recognition unit 42.

More specifically, the determination unit 44 determines whether or not the color parameter of the optical fiber F1 acquired by the recognition unit 42 matches with the color parameter of the optical fiber to be a first optical fiber, whether or not the color parameter of the optical fiber F2 matches with the color parameter of the optical fiber to be a second optical fiber, whether or not the color parameter of the optical fiber F3 matches with the color parameter of the optical fiber to be a third optical fiber, whether or not the color parameter of the optical fiber F4 matches with the color parameter of the optical fiber to be a fourth optical fiber, whether or not the color parameter of the optical fiber F5 matches with the color parameter of the optical fiber to be a fifth optical fiber, whether or not the color parameter of the optical fiber F6 matches with the color parameter of the optical fiber to be a sixth optical fiber, whether or not the color parameter of the optical fiber F7 matches with the color parameter of the optical fiber to be a seventh optical fiber, whether or not the color parameter of the optical fiber F8 matches with the color parameter of the optical fiber to be an eighth optical fiber, whether or not the color parameter of the optical fiber F9 matches with the color parameter of the optical fiber to be a ninth optical fiber, whether or not the color parameter of the optical fiber F10 matches with the color parameter of the optical fiber to be a tenth optical fiber, whether or not the color parameter of the optical fiber F11 matches with the color parameter of the optical fiber to be an eleventh optical fiber, and whether or not the color parameter of the optical fiber F12 matches with the color parameter of the optical fiber to be a twelfth optical fiber. In this manner, the determination unit 44 determines whether or not the color parameter of the optical fiber located at the n-th position in the imaged image matches with the color parameter of the optical fiber to be the n-th optical fiber, where n is a natural number.

“The target alignment order matches with” denotes “the color matches with” and “the alignment order of the optical fibers having the colors matches with”. “The colors match with” includes a case where the colors of the optical fibers F in the image match with the colors in the target alignment order and a case where the colors of the optical fibers F in the image roughly match with but do not completely match with the colors in the target alignment order. That is, “the target alignment order matches with” includes a case where each color in the actual measurement alignment order visually matches with each color in the target alignment order even in a case where each color in the actual measurement alignment order is strictly different from each color in the target alignment order. For example, the storage unit 43 has setting RGB values indicating the colors of each of the optical fibers F in the target alignment order, and the determination unit 44 may determine whether or not a difference between the RGB value of each optical fiber F acquired by the recognition unit 42 and the setting RGB value is a certain value or less. In this case, when the difference between the RGB values and the setting RGB values is the constant value or less, the determination unit 44 determines that the colors match with the colors in the target alignment order, and when the difference between the RGB values and the setting RGB values is not the constant value or less, the determination unit 44 determines that the colors do not match with the colors in the target alignment order. As a specific example, when the color of the optical fiber F in the target alignment order stored in the storage unit 43 is white (#FFFFFF) and the color code of the color of the optical fiber F in the actual measurement alignment order acquired by the recognition unit 42 is #FFFFFE, the determination unit 44 determines that the colors match with each other. On the other hand, when the color of the optical fibers F in the target alignment order stored in the storage unit 43 is white (#FFFFFF) and the color code of the color of the optical fibers F in the actual measurement alignment order acquired by the recognition unit 42 is #FFFFEF, the determination unit 44 determines that the colors do not match with each other. It is noted that the criteria for determining whether or not there is a match by the determination unit 44 can be changed as appropriate. For example, the allowable range of the difference between the acquired RGB value of each optical fiber F and the setting RGB value described above may be determined by machine learning.

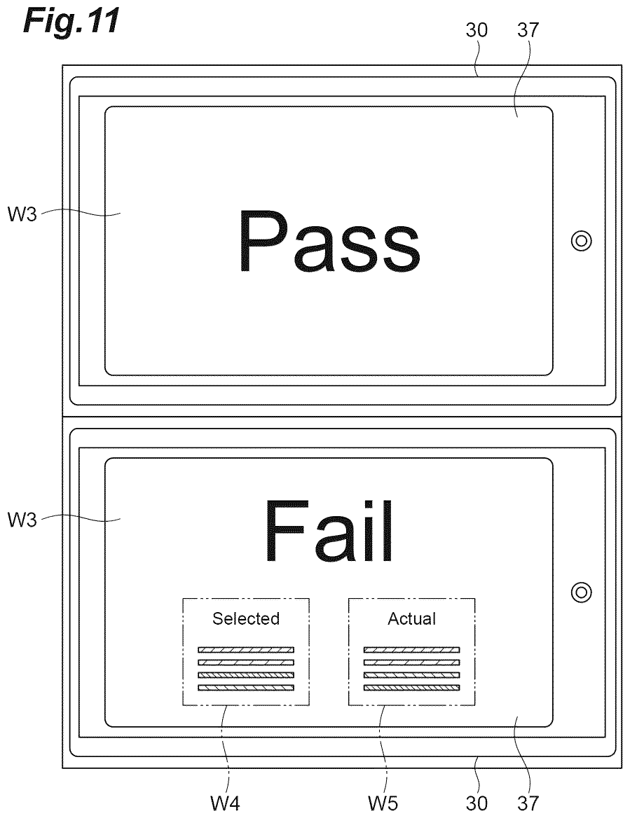

The output unit 45 displays the result of the determination by the determination unit 44 on the display 37 of the mobile terminal 30. For example, the output unit 45 is implemented by the CPU 31 of the mobile terminal 30 and the display 37 of the mobile terminal 30. FIG. 11 is a diagram illustrating a screen W3 as an example of the result of the determination displayed on the display 37. As illustrated in FIG. 11, when the determination unit 44 determines that the actual measurement alignment order of the optical fibers F matches with the target alignment order stored in the storage unit 43, “Pass” is displayed on the display 37. On the other hand, when the determination unit 44 determines that the actual measurement alignment order of the optical fibers F does not match with the target alignment order stored in the storage unit 43, “Fail” is displayed, and the alignment order of the optical fibers F is displayed. For example, an image W4 of the actual measurement alignment order of the optical fibers F and an image W5 of the target alignment order which is an appropriate alignment order of the optical fibers F are displayed on the display 37. Accordingly, the operator aligning the optical fibers F can recognize that there is an error in the alignment order of the aligned optical fibers F and can grasp the appropriate alignment order of the optical fibers F.

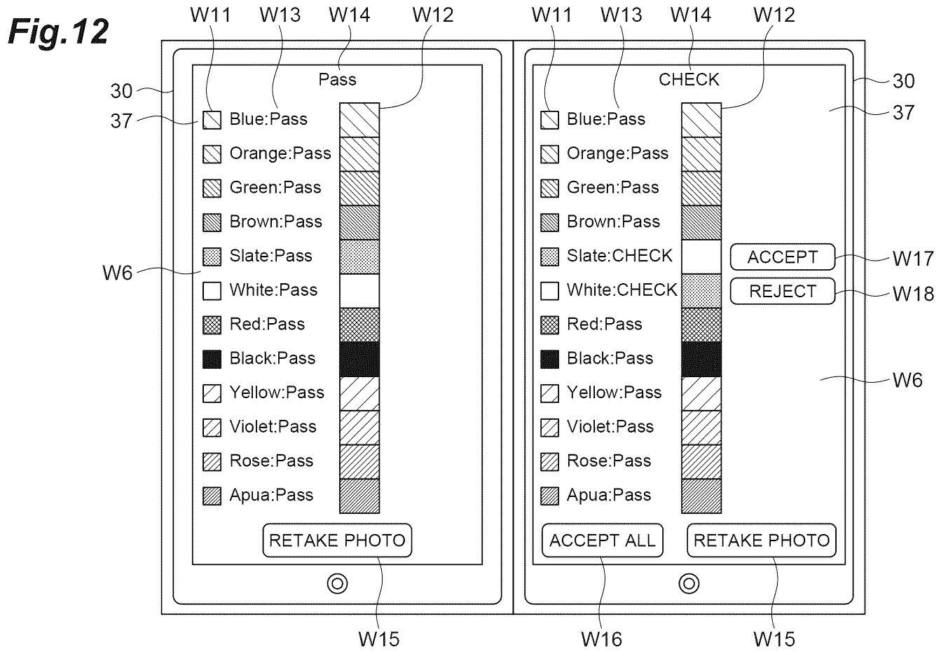

FIG. 12 is a diagram illustrating a screen W6 as another example of the result of the determination displayed on the display 37. The output unit 45 may display, for each optical fiber F, whether or not the actual measurement alignment order of the plurality of optical fibers F in the imaged image matches with the target alignment order stored in the storage unit 43. FIG. 12 illustrates an example where the actual measurement alignment order matches with the target alignment order and an example where the actual measurement alignment order of the optical fibers F5 and F6 does not match with the target alignment order of the optical fibers F5 and F6.

A target alignment order W11 of the optical fibers F stored in the storage unit 43 and an actual measurement alignment order W12 of the optical fibers F in the imaged image are displayed to be aligned with each other on the display 37. Accordingly, the operator can visually grasp whether or not the actual measurement alignment order of the optical fibers F is correct. Suitability W13 of the actual measurement alignment order for each optical fiber F is displayed on the display 37, and suitability W14 of the actual measurement alignment order of all the optical fibers F is displayed on the display 37. For example, for the suitability W13 of the actual measurement alignment order for each optical fiber F and the suitability W14 of the actual measurement alignment order of all the optical fibers F, “Pass” is displayed in an appropriate case, and “CHECK” is displayed in an inappropriate case. Further, a retake button W15 is displayed on the display 37. When the retake button W15 is pressed, the alignment of the optical fibers F is corrected, and the corrected plurality of optical fibers F are imaged again to allow the determination unit 44 to perform the determination. When the actual measurement alignment order of the optical fibers F is not appropriate, an accept button W16 to agree with the result of the determination by the determination unit 44 is displayed on the display 37, and an accept button W17 or a reject button W18 for each optical fiber F is displayed on the display 37.

The accept button W16 is a button for forcibly changing a determination state of the optical fiber F as a whole. Although the color acquired from the image and the target color are originally the same color, in some cases, due to measurement accuracy or dirt on the imaging unit (for example, lens), these colors may be erroneously determined as different colors. The accept button W16 is a button for confirming the state that the entire alignment order of the optical fibers F has no problem when all the colors and the alignment order are correct as a result of visual confirmation even in such a case. That is, when the accept button W16 is pressed, the color status of all the optical fibers F is switched from CHECK (indicating a meaning of required confirmation, required correction, error, or the like) to Pass (indicating a meaning of pass, no problem, agreement, or the like) in display.

The accept button W17 or the reject button W18 for each optical fiber F is a button for forcibly changing the determination state of the optical fiber F in which the button is displayed. When it is determined that the color of the specific optical fiber F is different from the target color and when it can be confirmed that the color is the same as the target color as a result of visual confirmation, the state where the color is aligned with the correct color is established by pressing the accept button W17. That is, when the accept button W17 is pressed, the status of the specific optical fiber F is switched from CHECK to PASS in display.

When it is determined that the color of the specific optical fiber F is different from the target color and when it can be confirmed that the color is different from the target color as a result of visual confirmation, the state where the color is different from the target color is established by pressing the reject button W18. That is, when the reject button W18 is pressed, the status of the specific optical fiber F is switched from CHECK to Fail (indicating failure, error, or the like) in display.

Heretofore, the screen W6 displayed on the display 37 by the output unit 45 has been illustrated. However, the aspect of the screen displayed on the display 37 by the output unit 45 is not limited to the above-described examples and can be changed as appropriate.

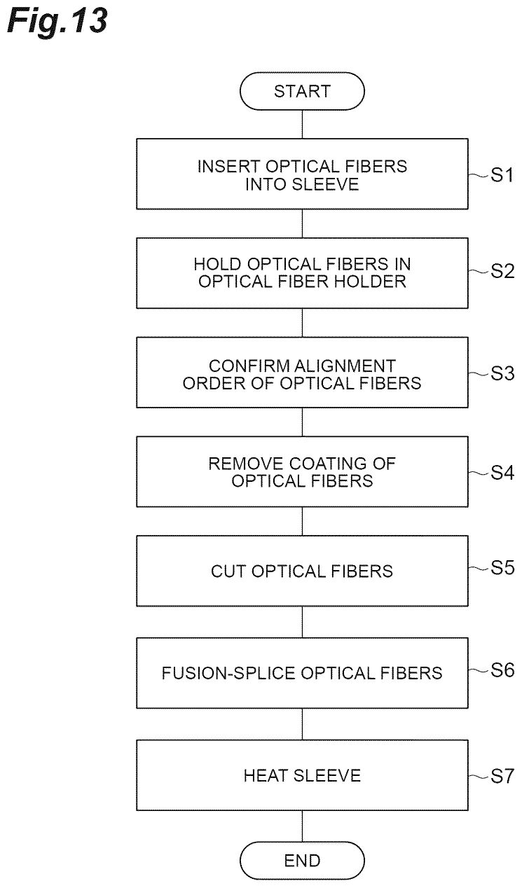

Next, an example of the processes of the fusion splicing method and the optical fiber identification method will be described with reference to FIG. 13. For example, the optical fiber identification method is performed during the processes of the fusion splicing method. In the fusion splicing method, for example, the plurality of optical fibers F are inserted inside the cylindrical sleeve (process of inserting optical fibers into the sleeve, step S1). At this time, the end portions of the plurality of optical fibers F are inserted into the sleeves with the plurality of optical fibers F extending from the sleeves. It is noted that the plurality of optical fibers F may be ribbonized. Ribbonizing indicates that the plurality of optical fibers F are arranged in parallel and integrated in a tape shape. Ribbonized portions of the plurality of optical fibers F are, for example, in a state of being hardened with adhesive.

Next, the plurality of optical fibers F are held in the optical fiber holder 11 (process of holding the plurality of optical fibers in the optical fiber holder, step S2). At this time, the plurality of unbundled optical fibers F may be placed on the optical fiber holder 11, or the plurality of ribbonized optical fibers F may be placed on the optical fiber holder 11. The optical fiber holder 11 holds the mounted plurality of optical fibers F, and the distal ends of the plurality of optical fibers F extend from the optical fiber holder 11.

After the plurality of optical fibers F are held by the optical fiber holder 11, the optical fiber identification method is executed to confirm the alignment order of the optical fibers F (step S3). The optical fiber identification method is executed by the optical fiber identification program 40 installed in the mobile terminal 30. In identifying the optical fiber F, first, as described above, the light shielding member 50 is mounted on the mobile terminal 30, and then, the imaging unit 41 images the plurality of optical fibers F extending from the optical fiber holder 11 (process of imaging the plurality of optical fibers).

After the imaging of the plurality of optical fibers F by the imaging unit 41, the determination unit 44 determines whether or not the actual measurement alignment order of the plurality of optical fibers F in the imaged image matches with the target alignment order stored in the storage unit 43 (process of determining). It is noted that the storage unit 43 stores in advance the target alignment order of the plurality of optical fibers F. However, the timing for storing the target alignment order in the storage unit 43 is not particularly limited. After the determination by the determination unit 44, the output unit 45 outputs the result of the determination (process of outputting). For example, as illustrated in FIG. 11, the output unit 45 displays “Pass” on the display 37 when the actual measurement alignment order of the plurality of optical fibers F is correct. When the actual measurement alignment order of the plurality of optical fibers F is incorrect, the output unit 45 displays, for example, “Fail” and displays the image W5 illustrating the target alignment order which is the appropriate alignment order of the optical fibers F together with the image W4 illustrating the actual measurement alignment order on the display 37. A series of processes of the optical fiber identification method is completed through the above-described processes.

After executing the optical fiber identification method to match the alignment order of the optical fibers F with the target alignment order, the coating of the optical fibers F is removed (process of removing the coating of the optical fibers, step S4). At this time, the coating of the distal end portion of each of the plurality of optical fibers F extending from the optical fiber holder 11 is removed, and the distal end portion of each optical fiber F is formed with a bare fiber (glass fiber) with the coating removed. Then, the distal end portions of the plurality of optical fibers F are cut so that the positions of the distal end portions are aligned (process of cutting the optical fibers, step S5). For example, the glass fiber portions of the plurality of optical fibers F are cut by a cleaver. By this cutting, the distal end portions of the plurality of optical fibers F in an extension direction of the optical fibers F are aligned.

Then, the optical fiber holder 11 holding the plurality of optical fibers F is installed in the fusion splicer 1, and the plurality of optical fibers F are fusion-spliced (process of fusion-splicing the plurality of optical fibers, step S6). More specifically, the optical fiber holder 11 holding the plurality of optical fibers F and the optical fiber holder 11 holding the plurality of optical fibers G are mounted on the respective holder mounting portions of the fusion splicing unit 4. The distal end portions of the optical fibers F and G held by the respective optical fiber holders 11 are positioned by the respective fiber positioning units 4b. Then, the pair of electrodes 4c fusion-splices the distal end portions of the optical fibers F and G. After the fusion splicing of the optical fibers F and G, the fusion splicing unit of the optical fibers F and G is covered with the sleeve, and the sleeve is heated and shrunk by the heater 5 (process of heating the sleeve, step S7). A series of processes is completed after the sleeve is heated and shrunk.

Next, functions and effects obtained from the fusion splicing system 20, the fusion splicing method, the optical fiber identification system 21, the optical fiber identification method, and the optical fiber identification program 40 according to the present embodiments will be described. In the fusion splicing system 20, the fusion splicing method, the optical fiber identification system 21, the optical fiber identification method, and the optical fiber identification program according to the present embodiments, the storage unit 43 stores the target alignment order of the plurality of optical fibers F having colors. The plurality of optical fibers F are imaged by the imaging unit 41. The determination unit 44 determines whether or not the actual measurement alignment order of the plurality of optical fibers F in the image imaged by the imaging unit 41 matches with the target alignment order. The result of the determination by the determination unit 44 is output by the output unit 45. An operator performing a work of aligning the plurality of optical fibers F can grasp whether or not the actual measurement alignment order of the plurality of optical fibers F in the imaged image matches with the target alignment order stored in the storage unit 43. Therefore, the operator can easily and accurately align the plurality of optical fibers F.

As described above, the imaging unit 41, the storage unit 43, the determination unit 44, and the output unit 45 may be an imaging unit 41, a storage unit 43, a determination unit 44, and an output unit 45 of the mobile terminal 30. The determination unit 44 may be implemented by an application installed in the mobile terminal 30. In this case, it is determined whether or not the actual measurement alignment order of the plurality of optical fibers F imaged by the imaging unit 41 of the mobile terminal 30 matches with the target alignment order, and the result of the determination is output to the mobile terminal 30. The operator can grasp the result of the determination by imaging the plurality of optical fibers F with the imaging unit 41 of the mobile terminal 30 and manipulating the mobile terminal 30. Therefore, the operator can more easily align the plurality of optical fibers F.

As described above, the fusion splicing system 20 and the optical fiber identification system 21 may include the light shielding member 50 having the holder mounting portion 70 in which the optical fiber holder 11 holding the plurality of optical fibers F is mounted, and the terminal mounting portion 60 in which the mobile terminal 30 is mounted. In the light shielding member 50, the lens of the camera of the mobile terminal 30 mounted on the terminal mounting portion 60 may face the plurality of optical fibers F held by the optical fiber holder 11 mounted on the holder mounting portion 70, and the light to the lens may be shielded. In this case, the camera of the mobile terminal 30 mounted on the terminal mounting portion 60 is shielded from the light and faces the plurality of optical fibers F held by the optical fiber holder 11. Accordingly, the light entering the camera of the mobile terminal 30 can be suppressed, and the camera can be allowed to face the plurality of optical fibers F, so that a clearer image of the optical fibers F can be acquired. Therefore, the accuracy of the determination of the plurality of optical fibers F can be further improved.

As described above, the output unit 45 may display, on the display 37 of the mobile terminal 30, whether or not the actual measurement alignment order of the plurality of optical fibers F in the imaged image matches with the target alignment order stored in the storage unit 43. In this case, whether or not the actual measurement alignment order of the optical fibers F is appropriate is displayed on the display 37 of the mobile terminal 30, so that the operator can easily grasp whether or not the actual measurement alignment order of the optical fibers F is appropriate.

As described above, the output unit 45 may display, for each optical fiber F, whether or not the actual measurement alignment order matches with the target alignment order. In this case, whether or not the actual measurement alignment order is appropriate is displayed for each optical fiber F, so that the suitability of the actual measurement alignment order can be grasped for each optical fiber F.

As described above, the output unit 45 may display the image W4 illustrating the actual measurement alignment order and the image W5 illustrating the target alignment order on the display 37. In this case, since the image W4 illustrating the actual measurement alignment order together with the image W5 illustrating the target alignment order is displayed on the display 37, the suitability of the actual measurement alignment order of the optical fibers F can be visually displayed in an easy-to-understand manner.

As described above, the fusion splicing method and the optical fiber identification method according to the embodiment may include the process of storing the target alignment order of the plurality of optical fibers F in the storage unit 43. In this case, the target alignment order to be stored in the storage unit 43 can be arbitrarily set.

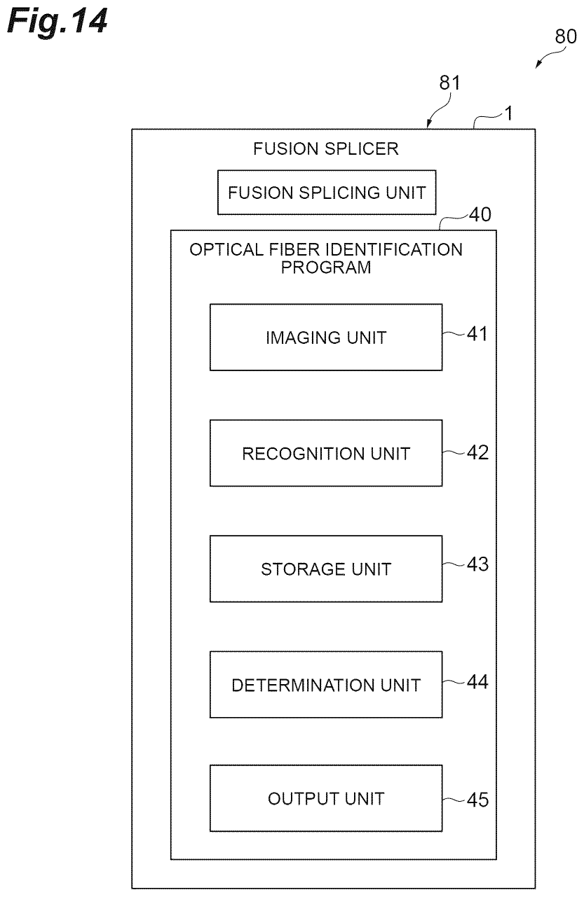

Next, Modified Examples of the fusion splicing system, the fusion splicing method, the optical fiber identification system, the optical fiber identification method, and the optical fiber identification program according to the present disclosure will be described with reference to FIGS. 14, 15 and 16. Some configurations of the fusion splicing system, the fusion splicing method, the optical fiber identification system, the optical fiber identification method, and the optical fiber identification program according to Modified Examples are the same as those of the configurations of the above-described embodiments. Therefore, hereafter, the description redundant to the description of the contents described above is denoted by the same reference numerals and omitted as appropriate.

FIG. 14 is a block diagram illustrating functions of a fusion splicing system 80 and an optical fiber identification system 81 according to Modified Example. In the fusion splicing system 80 and the optical fiber identification system 81, the optical fiber identification program 40 is incorporated into the fusion splicer 1. In the fusion splicing system 80, the imaging unit 41, the recognition unit 42, the storage unit 43, the determination unit 44, and the output unit 45 are an imaging unit 41, a recognition unit 42, a storage unit 43, a determination unit 44, and an output unit 45 of the fusion splicer 1, respectively. Similarly to the fusion splicing system 80, the optical fiber identification system 81 includes an imaging unit 41, a recognition unit 42, a storage unit 43, a determination unit 44, and an output unit 45. The determination unit 44 is implemented by software installed in the fusion splicer 1.

For example, the imaging unit 41 images the plurality of optical fibers F with the camera 6 of the fusion splicer 1. The imaging unit 41 is implemented by the CPU 10a (refer to FIG. 3) of the fusion splicer 1 and the camera 6. The recognition unit 42 is implemented by the CPU 10a of the fusion splicer 1 and the memory of the fusion splicer 1. The storage unit 43 is implemented by the memory of the fusion splicer 1. The determination unit 44 is implemented by the CPU 10a of the fusion splicer 1 operating according to commands of software installed in the fusion splicer 1. The output unit 45 is implemented by the CPU 10a of the fusion splicer 1 and the monitor 7.

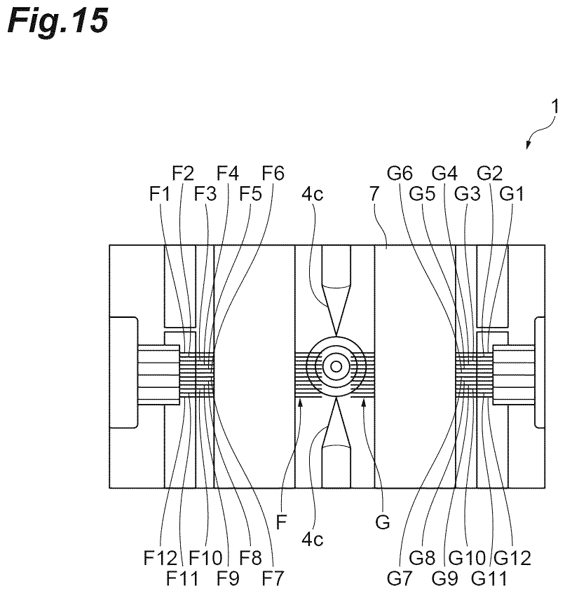

FIG. 15 illustrates an example of images of the plurality of optical fibers F and G imaged by the camera 6 and displayed on the monitor 7 of the fusion splicer 1. As illustrated in FIG. 15, for example, the optical fibers F1, F2, F3, F4, F5, F6, F7, F8, F9, F10, F11, and F12, the optical fibers G1, G2, G3, G4, G5, G6, G7, G8, G9, G10, G11, and G12, and the pair of electrodes 4c extending from the respective optical fiber holders 11 are displayed on the monitor 7. Furthermore, the colors of the plurality of optical fibers F and the colors of the plurality of optical fibers G imaged by the imaging unit 41 are displayed on the monitor 7 according to the alignment orders of the plurality of optical fibers F and G, respectively. In this case, the operator can easily grasp whether or not the alignment orders of the optical fibers F and G installed in the fusion splicer 1 are appropriate by watching the monitor 7.

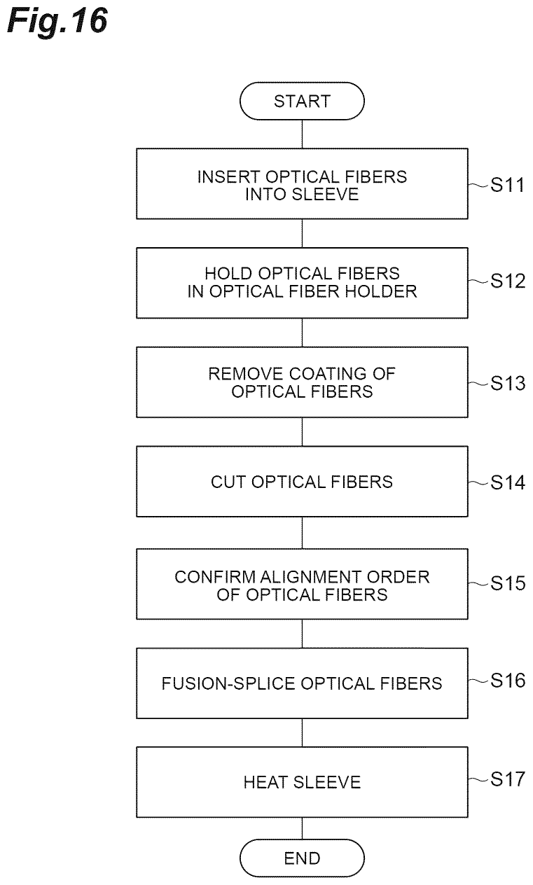

Next, a fusion splicing method and an optical fiber identification method according to Modified Example will be described with reference to FIG. 16. First, similarly to the above-described embodiment, the process of inserting the plurality of optical fibers F into a cylindrical sleeve (step S11) and the process of holding the plurality of optical fibers F in the optical fiber holder 11 (step S12) are executed. The contents of steps S11, and S12 are the same as the contents of steps S1 and S2 described above.

In the above-described embodiment, confirmation of the alignment order of the optical fibers F (step S3) is performed after step S2. On the other hand, in Modified Example, the coating of the optical fiber F is removed after step S12 (step S13), and the plurality of optical fibers F are cut (step S14). The contents of steps S13 and S14 are the same as the contents of steps S4 and S5 described above.

After cutting the plurality of optical fibers F, the optical fiber holder 11 holding the plurality of optical fibers F is installed in the fusion splicer 1. Then, before the fusion-splicing, the optical fiber identification method is executed to confirm the alignment order of the optical fibers F (step S15). Since the contents of step S15 are the same as the contents of step S3 described above, detailed description of step S15 will be omitted as appropriate.

In Modified Example, the optical fiber identification method is executed by the optical fiber identification program 40 installed in the fusion splicer 1. The result of the determination by the determination unit 44 of the optical fiber identification program 40 is displayed on the monitor 7 by the output unit 45. As a specific example, when the alignment order of the plurality of optical fibers F is correct, the output unit 45 displays “Pass” on the monitor 7, and when the alignment order of the plurality of optical fibers F is incorrect, the output unit 45 displays an appropriate alignment order of the optical fibers F along with display of “Fail” on the monitor 7. Thus, the aspect of the result of the determination displayed on the monitor 7 is the same as the aspect of the result of the determination displayed on the display 37 of the mobile terminal 30 described above. After performing the optical fiber identification method and allowing the alignment order of the optical fibers F to be appropriate, the plurality of optical fibers F are fusion-spliced (step S16). After the fusion splicing, the fusion splicing unit of the optical fiber F is covered with the sleeve, and the sleeve is heated and shrunk by the heater 5 (step S17). A series of the processes is completed through the above-described processes.

Heretofore, in the fusion splicing system 80, the optical fiber identification system 81, the optical fiber identification program 40, the fusion splicing method, and the optical fiber identification method according to Modified Example, the imaging unit 41, the recognition unit 42, the storage unit 43, the determination unit 44, and the output unit 45 are an imaging unit 41, a recognition unit 42, a storage unit 43, a determination unit 44, and an output unit 45 of the fusion splicer 1. The determination unit 44 is implemented by software installed in the fusion splicer 1. In this case, it is determined whether or not the actual measurement alignment order of the plurality of optical fibers F imaged by the imaging unit 41 of the fusion splicer 1 matches with the target alignment order, and the result of the determination is output to the monitor 7 of the fusion splicer 1. Therefore, the operator can grasp the result of the determination by imaging the plurality of optical fibers F with the imaging unit 41 of the fusion splicer 1 and manipulating the fusion splicer 1. Therefore, the operator can easily align the plurality of optical fibers F.

As an additional Modified Example, a fusion splicing system, an optical fiber identification system, an optical fiber identification program, a fusion splicing method, and an optical fiber identification method including a mobile terminal communicatively connected to a fusion splicer, and a server communicatively connected to the mobile terminal may be employed. Alternatively, a fusion splicing system, an optical fiber identification system, an optical fiber identification program, a fusion splicing method, and an optical fiber identification method including a server communicatively connected to a fusion splicer may be employed.

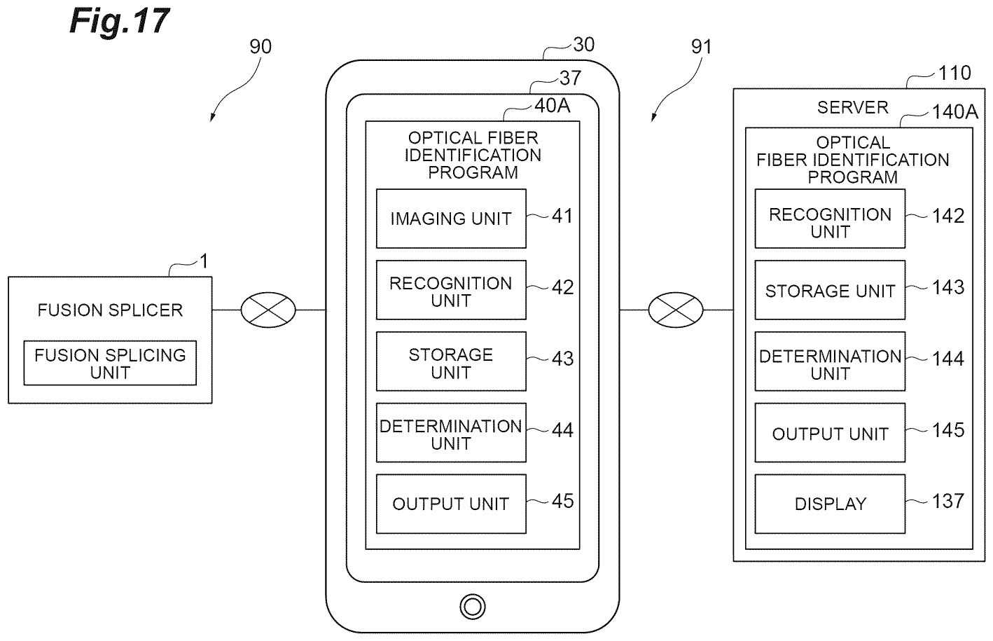

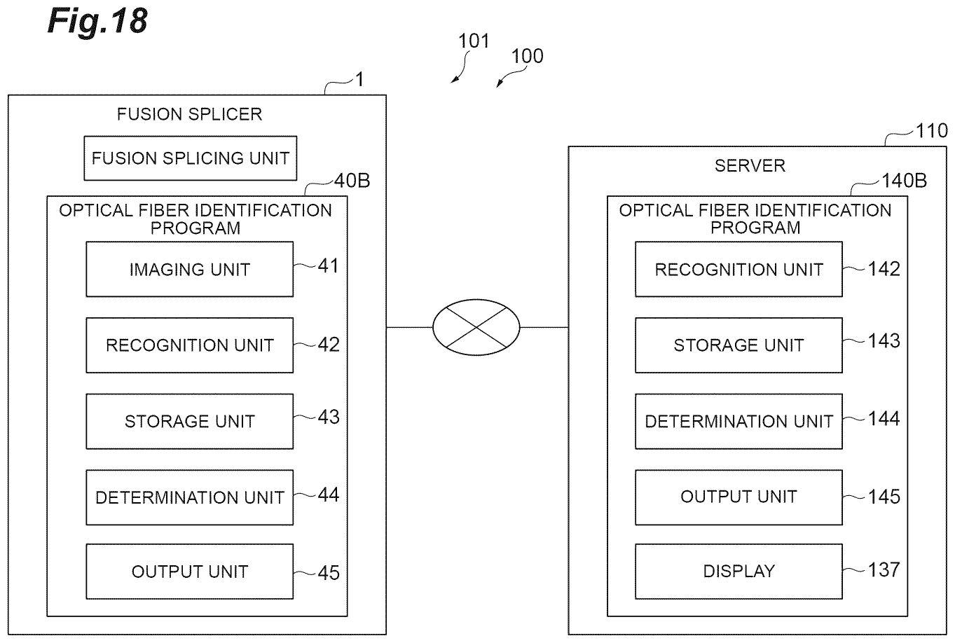

FIG. 17 is a block diagram illustrating functions of a fusion splicing system 90 and an optical fiber identification system 91 according to Modified Example. FIG. 18 is a block diagram illustrating functions of a fusion splicing system 100 and an optical fiber identification system 101 different from those in FIG. 17. As illustrated in FIGS. 17 and 18, the fusion splicing system 90, the optical fiber identification system 91, the fusion splicing system 100, and the optical fiber identification system 101 include a server 110.

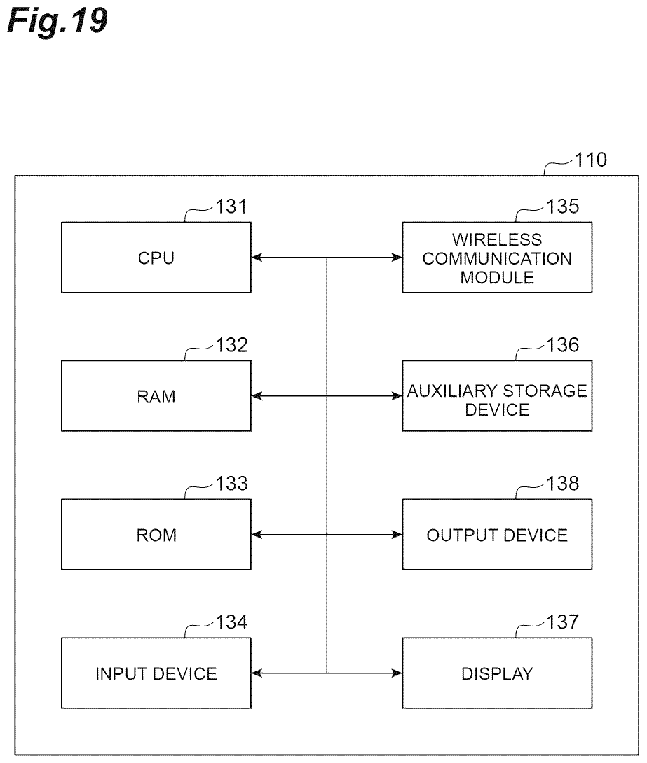

FIG. 19 is a diagram schematically illustrating a hardware configuration of the server 110. As illustrated in FIG. 19, the server 110 has a CPU 131, a RAM 132, a ROM 133, an input device 134, a wireless communication module 135, an auxiliary storage device 136, a display 137, and an output device 138. The functions of optical fiber identification programs 140A and 140B described later are implemented by operations of these components by a program.

As illustrated in FIG. 17, the fusion splicing system 90 has a fusion splicer 1, a mobile terminal 30, and a server 110. The fusion splicer 1 and the mobile terminal 30 are communicatively connected to each other, and the mobile terminal 30 and the server 110 are communicatively connected to each other. The optical fiber identification system 91 has a mobile terminal 30 and a server 110. For example, an optical fiber identification program 40A is installed in the mobile terminal 30, and an optical fiber identification program 140A is installed in the server 110. The mobile terminal 30 and the server 110 are communicatively connected to each other. In the optical fiber identification system 91, the imaging unit is an imaging unit 41 of the mobile terminal 30. In the optical fiber identification system 91, some of the recognition unit, the storage unit, the determination unit, and the output unit are a recognition unit 42, a storage unit 43, a determination unit 44, and an output unit 45 of the mobile terminal 30, and the others are a recognition unit 142, a storage unit 143, a determination unit 144 and an output unit 145 of the server 110. The fusion splicing system 90 is implemented by cooperation of the fusion splicer 1 with imaging units 41, recognition units 42 and 142, storage units 43 and 143, determination units 44 and 144, and output units 45 and 145 of the mobile terminal 30 and the server 110, respectively. The optical fiber identification system 91 is implemented by cooperation of the imaging unit 41, the recognition units 42 and 142, the storage units 43 and 143, the determination units 44 and 144, and the output units 45 and 145 of the mobile terminal 30 and the server 110, respectively. The determination units 44 and 144 are implemented by software installed in the mobile terminal 30 and the server 110, respectively.

As illustrated in FIG. 18, the fusion splicing system 100 and optical fiber identification system 101 have the fusion splicer 1 and the server 110. The fusion splicer 1 and the server 110 are communicatively connected to each other. The optical fiber identification program 40B is installed in the fusion splicer 1, and the optical fiber identification program 140B is installed in the server 110. The fusion splicer 1 and the server 110 are communicatively connected to each other. In the fusion splicing system 100 and the optical fiber identification system 101, the imaging unit is an imaging unit 41 of the fusion splicer 1; some of the recognition unit, the storage unit, the determination unit, and the output unit are a recognition unit 42, a storage unit 43, a determination unit 44, and an output unit 45 of the fusion splicer 1; and the others are a recognition unit 142, a storage unit 143, a determination unit 144, and an output unit 145 of the server 110. The fusion splicing system 100 and the optical fiber identification system 101 are implemented by cooperation of the imaging unit 41, the recognition units 42 and 142, the storage units 43 and 143, the determination units 44 and 144, and the output units 45 and 145 of the fusion splicer 1 and the server 110, respectively. The determination units 44 and 144 are implemented by software installed in the fusion splicer 1 and software installed in the server 110.

Heretofore, the embodiments and Modified Examples have been described. However, the present invention is not limited to the above-described embodiments or Modified Examples, and various Modified Examples are possible without changing the spirit of the claims. For example, in the embodiment described above, the example where the operator stores the target alignment order in the storage unit 43 by using the mobile terminal 30 has been described. However, the operator may store the target alignment order in the storage unit 43 of the fusion splicer 1 as in Modified Example described above. Furthermore, the storing of the target alignment order in the storage unit 43, particularly, the storing of the color information may be performed, for example, by machine learning, and the aspect of storing of the target alignment order in the storage unit 43 is not particularly limited.

When the color criteria is newly created, added, and updated, etc. it is more efficient to perform these processes with the storage unit 143 of the server 110. The color criteria obtained as such is stored in the storage unit 143 of the server 110. Alternatively, the above-described machine learning process may be performed in the storage unit 143 of the sever 110, and the range of the color criteria finally acquired, for example, the range or table of the color parameters that can be determined as “red”, may be stored in the fusion splicer 1 or the storage unit 43 of the mobile terminal 30. Naturally, the machine learning process may be performed in the fusion splicer 1 or the storage unit 43 of the mobile terminal 30.

In the above-described embodiment, the output unit 45 displaying whether or not the actual measurement alignment order matches with the target alignment order on the display 37 of the mobile terminal 30 has been described. However, the output unit may output whether or not the actual measurement alignment order matches with the target alignment order in an aspect other than display. For example, the output unit may output by voice whether or not the actual measurement alignment order matches with the target alignment order. In this manner, the aspect of outputting the result of the determination by the output unit is not particularly limited.

In the above-described embodiment, the example where the number of optical fibers F and G is 12 has been described. However, the number of optical fibers F and G is not particularly limited as long as the number of optical fibers is plural. Furthermore, in the above-described embodiment, the imaging unit 41 performs imaging with the camera provided in the mobile terminal 30, and in the above-described modified example, the imaging unit 41 performs imaging with the camera 6 provided in the fusion splicer 1. However, various cameras used by the imaging unit 41 for imaging can be employed. The camera used by the imaging unit 41 for imaging may be arranged in the cleaver cutting, for example, the optical fiber F. The camera used by the imaging unit 41 for imaging may be an independent camera or may be a camera capable of communicating with the mobile terminal 30 or the fusion splicer 1. In this manner, the camera used by the imaging unit 41 for imaging can be arranged in various places, and the aspect of the camera is not particularly limited. Furthermore, the optical fiber identification system may be a system independent of the mobile terminal 30 and the fusion splicer 1.

In the above-described embodiment, the example where the colors of the plurality of optical fibers F are different from each other has been described. With respect to the colors of the plurality of optical fibers F, all of the plurality of optical fibers F may have different colors as described above, or some of the plurality of optical fibers F may have the same color. For example, when k is a natural number of three or more, two or more and k−1 or less optical fibers F among the k optical fibers F may have the same color. Therefore, the color of the optical fiber that is a measurement target is not particularly limited.

### REFERENCE SIGNS LIST

1: fusion splicer, 2: housing, 3: cover, 3b: side face, 3c: inlet, 4: fusion splicing unit, 4b: fiber positioning unit, 4c: electrode, 5: heater, 6: camera, 7: monitor, 10a: CPU, 10b: RAM, 10c: ROM, 10d: input device, 10e: wireless communication module, 10f: auxiliary storage device, 10g: output device, 10h: GPS, 11: optical fiber holder, 20: fusion splicing system, 21: optical fiber identification system, 30: mobile terminal, 31: CPU, 32: RAM, 33: ROM, 34: input device, 35: wireless communication module, 36: auxiliary storage device, 37: display, 38: output device, 40, 40A, 40B: optical fiber identification program, 41: imaging unit, 42: recognition unit, 43: storage unit, 44: determination unit, 45: output unit, 50: light shielding member, 60: terminal mounting portion, 61: lens facing portion, 62: holding mechanism, 70: holder mounting portion, 71: attachment portion, 71b: hole, 72: arrangement portion, 72b: main face, 72c: first end face, 72d: second end face, 72f: hole, 72g: insertion portion, 80: fusion splicing system, 81: optical fiber identification system, 90, 100: fusion splicing system, 91, 101: optical fiber identification system, 110: server, 140A, 140B: optical fiber identification program, F, F1, F2, F3, F4, F5, F6, F7, F8, F9, F10, F11, F12, G, G1, G2, G3, G4, G5, G6, G7, G8, G9, G10, G11, G12: optical fiber, W1: setting screen, W2, W3, W6: screen, W4, W5: image, W11: target alignment order, W12: actual measurement alignment order, W13, W14: suitability, W15: retake button, W16, W17: accept button, W18: reject button.

What is claimed is:

1. A fusion splicing system comprising:
an imaging unit imaging a plurality of optical fibers having colors;
a storage unit storing a target alignment order which is an alignment order of target colors of the plurality of optical fibers;
a determination unit determining whether or not an actual measurement alignment order which is an alignment order of the colors of the plurality of optical fibers in an image imaged by the imaging unit matches with the target alignment order stored in the storage unit;
an output unit outputting a result of the determination by the determination unit; and
a fusion splicing unit fusion-splicing the plurality of optical fibers.

2. The fusion splicing system according to claim 1,
wherein the imaging unit is an imaging unit of a mobile terminal,
wherein at least a portion of the determination unit is at least a portion of a determination unit of the mobile terminal, and
wherein the determination unit is implemented by an application installed in the mobile terminal.

3. The fusion splicing system according to claim 2, further comprising a light shielding member having a holder mounting portion on which an optical fiber holder holding the plurality of the optical fibers is mounted and a terminal mounting portion on which the mobile terminal is mounted,
wherein, in the light shielding member, a lens of a camera of the mobile terminal mounted on the terminal mounting portion faces the plurality of optical fibers held by the optical fiber holder mounted on the holder mounting portion, and a light to the lens is shielded.

4. The fusion splicing system according to claim 3, wherein the holder mounting portion has an attachment portion detachably mounted on the terminal mounting portion and an arrangement portion in which the optical fiber holder holding the plurality of the optical fibers is arranged.

5. The fusion splicing system according to claim 4,
wherein the terminal mounting portion has a lens facing portion facing the lens of the camera of the mobile terminal, and
wherein the attachment portion has a hole into which the lens facing portion is fitted.

6. The fusion splicing system according to claim 1, wherein the output unit displays whether or not the actual measurement alignment order matches with the target alignment order on the display of the mobile terminal.

7. The fusion splicing system according to claim 6, wherein the output unit displays whether or not the actual measurement alignment order matches with the target alignment order for each optical fiber on the display.

8. The fusion splicing system according to claim 6, wherein the output unit displays an image illustrating the actual measurement alignment order and an image illustrating the target alignment order on the display.

9. The fusion splicing system according to claim 1,
wherein the imaging unit is an imaging unit of a fusion splicer,
wherein at least a portion of the determination unit is at least a portion of a determination unit of the fusion splicer, and
wherein the determination unit is implemented by software installed in the fusion splicer.

10. The fusion splicing system according to claim 9,
wherein the fusion splicer has a housing, a cover covering the housing, and a camera mounted inside the cover, and
wherein the imaging unit images the plurality of optical fibers with the camera.

11. A fusion splicing method comprising:
imaging a plurality of optical fibers having colors;
determining whether or not an actual measurement alignment order which is an alignment order of the colors of the plurality of optical fibers in an image imaged in the imaging matches with a target alignment order stored in a storage unit;
outputting a result of the determination in the determining; and
fusion-splicing the plurality of optical fibers.

12. An optical fiber identification system comprising:
an imaging unit imaging a plurality of optical fibers having colors;
a storage unit storing a target alignment order which is an alignment order of target colors of the plurality of optical fibers;
a determination unit determining whether or not an actual measurement alignment order which is an alignment order of the colors of the plurality of optical fibers in an image imaged by the imaging unit matches with the target alignment order stored in the storage unit; and
an output unit outputting a result of the determination by the determination unit.

13. An optical fiber identification method comprising:
imaging a plurality of optical fibers having colors;
determining whether or not an actual measurement alignment order which is an alignment order of the colors of the plurality of optical fibers in an image imaged in the imaging matches with a target alignment order stored in a storage unit; and
outputting a result of the determination in the determining.

14. The optical fiber identification method according to claim 13, further comprising storing the target alignment order in the storage unit.

15. A computer-readable recording medium recording an optical fiber identification program to execute:
imaging a plurality of optical fibers having colors;
determining whether or not an actual measurement alignment order which is an alignment order of the colors of the plurality of optical fibers in an image imaged in the imaging matches with a target alignment order stored in the storage unit; and
outputting a result of the determination in the determining.

16. The recording medium according to claim 15, wherein the optical fiber identification program further comprising storing the target alignment order in the storage unit by manipulation of a mobile terminal is recorded.
